(19) United States
(12) Patent Application Publication
(10) Pub. No.: US 2007/0257778 A1
(43) Pub. Date: Nov. 8, 2007

(54) Projection apparatus

(75) Inventors: Chih-Neng Tseng, Hukou Shiang (TW); Chih-Nan Wu, Hukou Shiang (TW); Po-Liang Chen, Hukou Shiang (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/651,995

(22) Filed: Jan. 11, 2007

(30) Foreign Application Priority Data
May 5, 2006 (TW) 95116028

(51) Int. Cl. G06F 7/02

(52) U.S. Cl. 340/146.2

(57) ABSTRACT

A projection apparatus includes a first wireless unit receiving signals from a first external wireless remote controller, a second external wireless unit receiving signals from a second wireless remote controller, a signal-processing unit respectively coupled with the first wireless unit and the second wireless unit to receive signals, a CPU coupled with the signal-processing unit to receive processed signals from the signal-processing unit, and a projecting unit coupled with the CPU to perform a projecting function in accordance with the signal transmitted from the CPU.

### RELATED APPLICATION

This application claims the benefit of Taiwan Application Serial No. 95116028 filed May 5, 2006.

### BACKGROUND OF THE INVENTION

1. Field of the Invention

The present invention relates to a projection apparatus, and more particularly, to a projection apparatus which can receive at least two kinds of wireless signals.

2. Description of the Prior Art

FIG. 1 is a schematic diagram of a system of a conventional projection apparatus 100. An infrared (IR) remote controller 142 emits a signal via the IR ray. The IR signal is decoded by the micro-controller 120, through the IR demodulator 140, to operate the functions of a conventional projection apparatus 100, or to operate a computer 150 via a universal serial bus (USB) interface, by recognizing the mouse function and page-up/page-down functions using the USB controller 130.

The IR remote controller has the transmission-length limitation of about 7 to 10 meters and the angle-limitation of about 15 degrees. Therefore, there may be some problems for users in a large meeting room. For example, the transmission of the IR ray is insensitive or the IR remote controller needs to be precisely aimed at the IR receiver of the projector.

### SUMMARY OF THE INVENTION

One object of the present invention is to provide a projection apparatus, which can receive at least two kinds of wireless signals to enhance the convenience for the user.

Other objectives, features and advantages of the present invention will be further understood from the further technology features disclosed by the embodiments of the present invention wherein there is shown and described a preferred embodiment of this invention, simply by way of illustration of one of the modes best suited to carry out the invention.

To achieve the one, some or all objects mentioned above, one embodiment of the present invention is to provide a projection apparatus. The projection apparatus includes a first wireless unit receiving the signal from a first external wireless remote controller, a second wireless unit receiving the signal from a second external wireless remote controller, a signal-processing unit respectively coupled with the first wireless unit and the second wireless unit to receive the signals from the first and second external wireless remote controllers respectively, a central processing unit (CPU) coupled with the signal-processing unit to receive a first output signal from the signal-processing unit, and a projecting unit coupled with the CPU to perform the projecting function in accordance with the signal transmitted from the CPU.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic diagram of a system of a conventional projection apparatus;

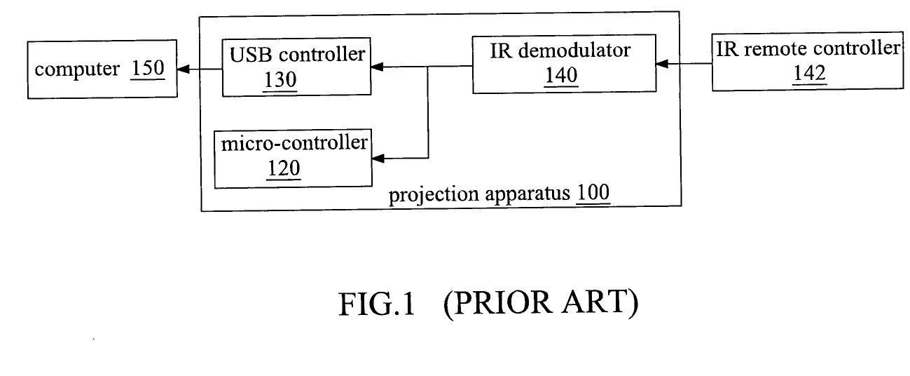

FIG. 2 is a schematic diagram of a system of a projection apparatus according to one embodiment of the present invention;

FIG. 3 is a schematic diagram of a system of a projection apparatus according to another embodiment of the present invention; and

FIG. 4 is a schematic diagram of a system of a projection apparatus according to still another embodiment of the present invention;

### DESCRIPTION OF THE PREFERRED EMBODIMENT

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

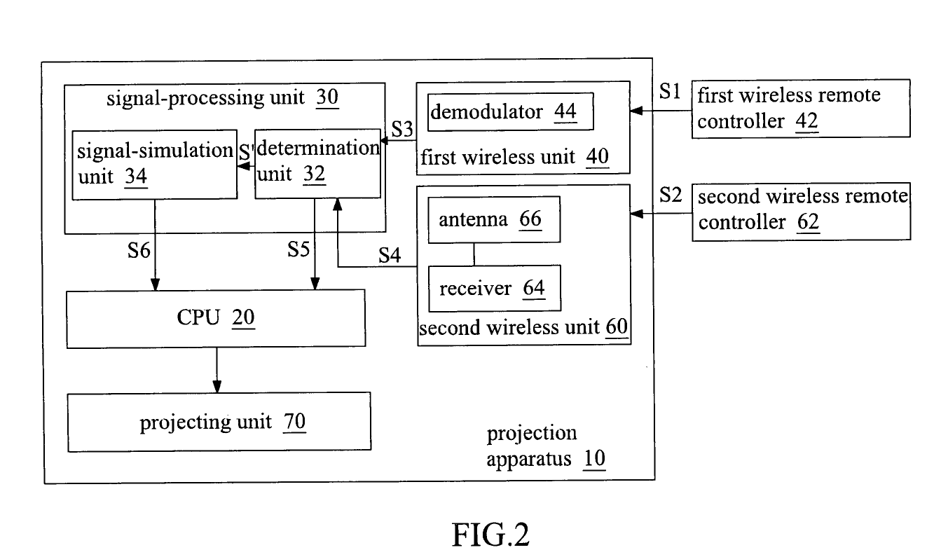

FIG. 2 is a schematic diagram of a system of a projection apparatus according to one embodiment of the present invention. A projection apparatus 10 includes a first wireless unit 40, a second wireless unit 60, a signal-processing unit 30, a CPU 20, and a projecting unit 70. The signal-processing unit 30 is respectively coupled with the first wireless unit 40 and the second wireless unit 60, and the CPU 20 is respectively coupled with the signal-processing unit 30 and the projecting unit 70.

As shown in FIG. 2, the first wireless unit 40, which is for example an IR unit, receives a signal S1 which is for example an IR signal transmitted from a first wireless remote controller 42 which is, for example, an external IR remote controller. The first wireless unit 40 includes a demodulator 44. The second wireless unit 60, which is for example a radio frequency (RF) unit, receives a signal which is for example a RF signal S2 transmitted from a second wireless remote controller 62 which is, for example, an external RF remote controller. The second wireless unit 60 includes a receiver 64 and an antenna 66. The signal-processing unit 30 includes a determination unit 32 and a signal-simulation unit 34.

The first wireless unit 40 receives the signal S1. The signal S1 is demodulated by the demodulator 44 to a signal S3. The first wireless unit 40 then transmits the signal S3 to the signal-processing unit 30. The second wireless unit 60 receives a signal S2, and converts the signal S2 to a signal S4 via the receiver 64, such as converting a high frequency signal to a low frequency signal. The second wireless unit 60 then transmits signal S4 to the signal-processing unit 30. The determination unit 32 of the signal-processing unit 30 includes a look-up table, for example, which is used to make a determination whether the signal S3 or the signal S4 needs to be simulated or not. The signal-simulation unit 34 proceeds with the signal-simulation by using a firmware.

After the determination unit 32 receives and determines that the signal S3 or the signal S4 needs to be simulated, a second output signal, such as a signal S′ from the determination unit 32 is then transmitted to the signal-simulation unit 34 to do a signal simulation and then a first output signal, such as a simulated signal S6 from the signal-simulation unit 34, is transmitted to the CPU 20. The CPU 20 is then to control the projecting unit 70 to project an image light beam to display an image onto a screen (not shown), or to control the full operation functions of the projection apparatus 10, such as adjusting the brightness, contrast and projection-mode, or mode of projection.

For example, in one embodiment, CPU 20 can only receive the wireless RF signal. The signal S1, such as the wireless IR signal emitted from the first wireless remote controller 42, is received by the first wireless unit 40 and demodulated by the demodulator 44, and then the demodulated signal 83 is transmitted to the signal-processing unit 30. After determination process by the determination unit 32, a second output signal, such as the signal S′ corresponding to the demodulated signal 83, is transmitted to the signal-simulation unit 34. Then, the first output signal, such as, the wireless RF signal 86, which is able to be accepted by the CPU 20, is simulated by the signal-simulation unit 34 in accordance with the demodulated wireless IR signal. The simulated wireless RF signal 86 then is transmitted from the signal-simulation unit 34 to the CPU 20.

If the determination unit 32 receives and determines that the signal 83 or the signal 84 is not required to be simulated, a first output signal, such as a signal 85 corresponding to the received signal received by the determination unit 32, is transmitted to the CPU 20 from the determination unit 32 and then the CPU 20 controls the projecting unit 70 to project the image light beam to display the image onto the screen or controls the full operation functions of the projection apparatus 10. In this embodiment, the signal-processing unit 30 is a USB control chip, such as a Cypress or a Cy7c63723 USB control chip.

The projecting unit 70 includes an illumination system (not shown in the figure), a light-valve (not shown in the figure) and a projection lens (not shown in the figure). The illumination system includes a light source to provide an illumination light beam which is subsequently transformed into the image light beam by the light-valve. The image light beam is then projected by the projection lens to display the image onto the screen.

The projection apparatus 10 in this embodiment is capable of receiving the signals from the wireless remote controllers without the transmission-length limitation and the angle-limitation. The projection apparatus 10 can receive at least two kinds of wireless signals, which one of the wireless signals can be signal-simulated by using a firmware so that the existing system can be applied. The users choose one kind of the remote controller to meet their own demand as the projection apparatus 10 can receive at least two kinds of wireless signals.

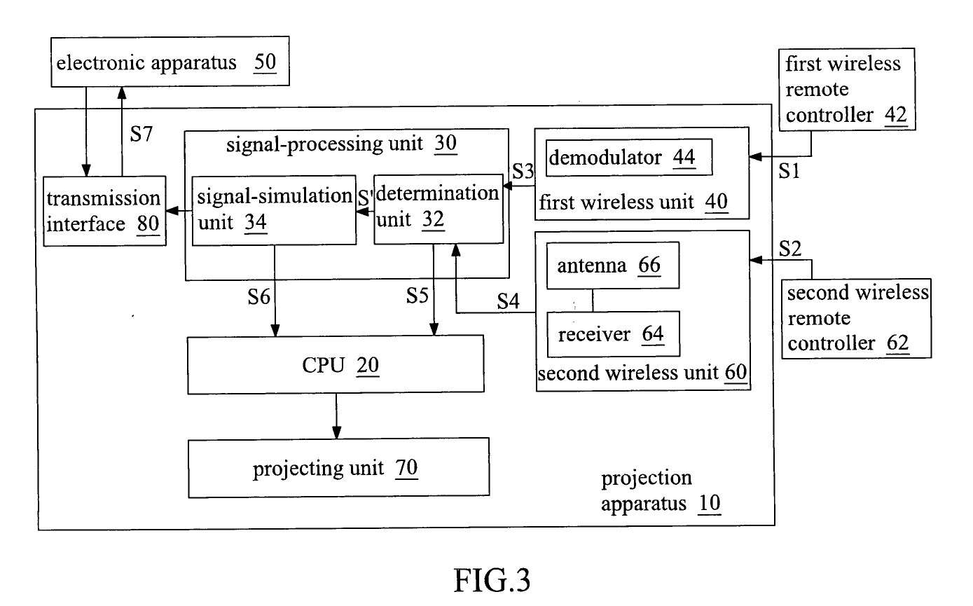

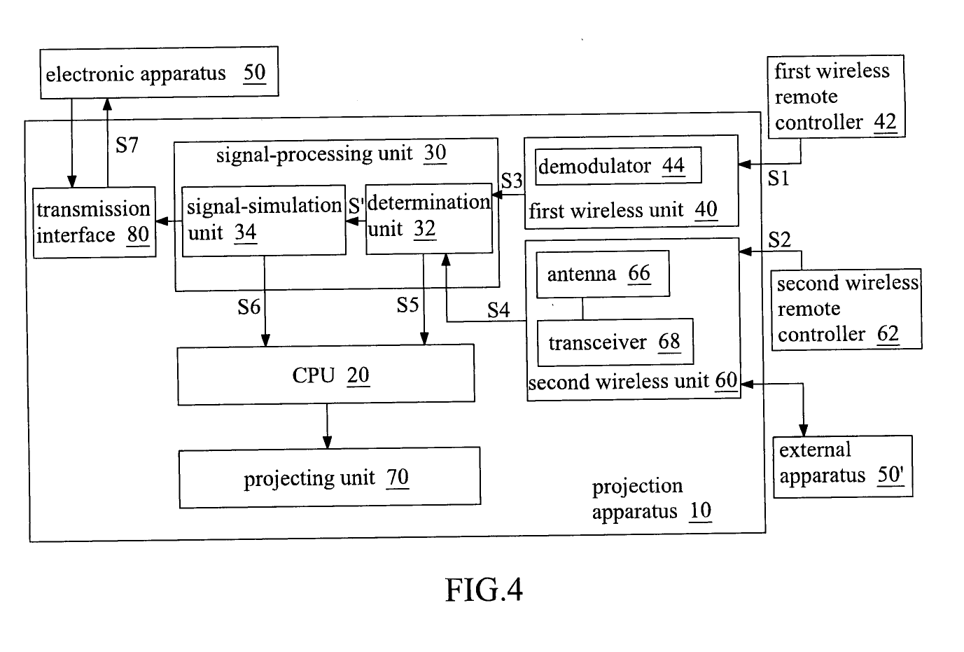

FIG. 3 and FIG. 4 are the schematic diagrams of a the systems of the projection apparatuses according to different embodiments of the present invention. The basic structures in FIG. 3 and FIG. 4 is the same as that in the embodiment in FIG. 2 and does not require to be described furthermore.

Please refer to FIG. 3. In this embodiment, a transmission interface 80 is coupled with the signal-processing unit 30 to transmit signals to an external electronic apparatus 50. The first wireless unit 40 and the second wireless unit 60 receive the signals S1, S2 transmitted from the first wireless remote controller 42 and the second wireless remote controller 62 respectively and transmit the demodulated or converted signals S3, S4 that are demodulated or converted from S1, S2 respectively to the signal-processing unit 30. The signal-processing unit 30 transmits a control signal S7 to the electronic apparatus 50 via the transmission interface 80 to proceed with the remote control. The users can remotely control the electronic apparatus 50 directly via the remote controller. The transmission interface 80 is for example a USB transmission-port and the electronic apparatus 50 is for example a computer. The first wireless remote controller 42 and the second wireless remote controller 62 have some functions, such as a mouse function and page-up/page-down functions. The user can control the computer and change pages using the mouse in the remote controller set in a long distance. Because the projection apparatus 10 according to the present invention receives sensitively wireless remote control signal without the problems of transmission-length limitation and the angle-limitation as compared with the conventional art, the user in a large meeting room can effectively control the projection apparatus 10.

Please refer to FIG. 4. It is different from the embodiment described in FIG. 2. In this embodiment, the second wireless unit 60 includes an antenna 66 and a transceiver 68. The transceiver 68 is the combination of a receiver and a transmitter. Therefore, the second wireless unit 60 can further receive a signal from an external apparatus 50′ having the function of wireless transmission, such as a personal digital assistant (PDA), a notebook computer, or a 3G communication product. Consequently, the projection apparatus 10 displays files inputted by the wireless transmission from the external apparatus 50′. On the other hand, the transceiver 68 and the antenna 66 of the second wireless unit 60 can emit signals to the apparatus 50′ having the function of wireless transmission. Therefore, the projection apparatus 10 and the apparatus 50′ can be controlled by the second wireless remote controller 62.

According to the above description, one feature of the present invention is to provide a projection apparatus which can receive the wireless IR signal and the wireless RF signal from the IR remote controller and RF remote controller respectively. The system adds a RF receiver in the projector and reserves the original IR demodulator. The IR demodulated data and the received RF data are integrated by signal-processing unit, such as the USB controller. If the data are function control codes, the USB controller simulates the IR signal and then transmits the simulated signal to the CPU. The CPU decodes it to operate the functions of the projection apparatus. If the data are the mouse control function and the page-up/page-down control functions, the USB controller operates the computer via the transmission interface, such as the USB interface. The present invention is not required to change the CPU design. It only adds, for example, a firmware to the original USB controller in accordance with the design requirements. Consequently, the product cost doesn't need to increase and the present invention is easy to be implemented.

To sum up, the system of the present invention can be designed to use the RF remote controller to remotely control the projection apparatus. A transmission-length of the RF remote controller can reach tens of meters and even farther. Additionally, the RF remote controller generally has no angle-limitation that the user doesn't need to precisely aim at the RF receiver of the projector, therefore, the sensitivity problem of the IR remote controller is solved. Furthermore, the IR demodulator is reserved in the system of the present invention. Therefore, the IR remote controller can compatibly operate the projection apparatus in addition to the RF remote controller.

The foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to particular use contemplated. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It is intended that the scope of the invention be defined by the Claims appended hereto and their equivalents. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. Moreover, no element and component in the present disclosure is intended to be dedicated to the public regardless of whether the element or component is explicitly recited in the following claims.

What is claimed is:

1. A projection apparatus, comprising:
a first wireless unit receiving a first signal from a first external wireless remote controller;
a second wireless unit receiving a second signal from a second external wireless remote controller;
a signal-processing unit respectively coupled with said first wireless unit and said second wireless unit to receive said first signal and said second signal respectively;
a central processing unit (CPU) coupled with said signal-processing unit to receive a first output signal from said signal-processing unit; and
a projecting unit coupled with said CPU to perform a projecting function in accordance with a signal transmitted from said CPU.

2. The projection apparatus according to claim 1, wherein said first wireless unit is an infrared (IR) unit.

3. The projection apparatus according to claim 1, wherein said second wireless unit is a wireless radio frequency (RF) unit.

4. The projection apparatus according to claim 1, wherein said first wireless unit comprises a demodulator.

5. The projection apparatus according to claim 1, wherein said second wireless unit comprises an antenna and a receiver.

6. The projection apparatus according to claim 1, wherein said second wireless unit is selected from a group consisting of a transmitter and a transceiver.

7. The projection apparatus according to claim 1, wherein said signal-processing unit comprises a determination unit and a signal-simulation unit.

8. The projection apparatus according to claim 7, wherein said determination unit comprises a look-up table to compare with said first signal transmitted from said first wireless unit, and transmits said first output signal to said CPU.

9. The projection apparatus according to claim 7, wherein said determination unit comprises a look-up table used to compare with said second signal transmitted from said second wireless unit and transmits a second output signal corresponding to said second signal to said signal-simulation unit.

10. The projection apparatus according to claim 9, wherein said signal-simulation unit simulates said second output signal and transmits said first output signal corresponding to a simulated signal generated by said signal-simulation unit to said CPU.

11. The projection apparatus according to claim 7, wherein said signal-simulation unit comprises a firmware to proceed with a signal-simulation.

12. The projection apparatus according to claim 1, wherein said CPU is a universal serial bus (USB) control chip.

13. The projection apparatus according to claim 1, wherein a transmission interface is coupled with said signal-processing unit to proceed with a signal-transmission with an external electronic apparatus.

14. The projection apparatus according to claim 1, wherein said second wireless unit is used to receive a signal from an external apparatus having a function of wireless transmission.

15. The projection apparatus according to claim 1, wherein said projecting unit comprises:
an illumination system comprising a light source to provide a illumination light beam;
a light-valve transforming said illumination light beam into an image light beam; and
a projection lens projecting said image light beam to display an image onto a screen.
